(19) United States
(12) Patent Application Publication
(10) Pub. No.: US 2015/0058809 A1
(43) Pub. Date: Feb. 26, 2015

(54) MULTI-TOUCH GESTURE PROCESSING

(71) Applicant: General Electric Company, Schenectady, NY (US)

(72) Inventors: Robert William Grubbs, Blue Ridge, VA (US); Justin Varkey John, Cohoes, NY (US)

(73) Assignee: General Electric Company, Schenectady, NY (US)

(21) Appl. No.: 13/974,128

(22) Filed: Aug. 23, 2013

(51) Int. Cl. G06F 3/0488

(52) U.S. Cl. CPC G06F 3/04883
USPC 715/863; 345/173

(57) ABSTRACT

One aspect of the invention is a system for multi-touch gesture processing. The system includes a multi-touch display and processing circuitry coupled to the multi-touch display. The processing circuitry is configured to detect a gesture on a gesture target area of a panel toolbar associated with a panel displayed on the multi-touch display. The panel includes panel content displayed in a content area. The gesture target area includes an empty area absent one or more command icons. Based on detection of the gesture, additional content is displayed on the multi-touch display associated with the panel content.

### BACKGROUND OF THE INVENTION

The subject matter disclosed herein relates to computer system user interfaces, and more particularly, to multi-touch gesture processing for a multi-touch computer system.

A multi-touch device can recognize the presence of two or more points of contact on a touch-sensitive surface. In a multi-touch enabled graphical user interface (GUI), gestures are sequences of touch input that are assigned meaning by software. Typical gestures include a tap, double-tap, tap-hold, pinch-zoom, swipes, and the like. A typical GUI has graphical regions (usually rectangular) dedicated to particular tasks or functions. One such example is a window as presented by the Microsoft Windows operating system (Windows is a registered trademark of Microsoft Corporation in the United States and other countries.). A window is typically subdivided further into controls or panels, including a region or panel dedicated to commands such as close or minimize, along with a title bar region that is either blank or contains text describing the contents of the window. The title bar region of a window typically supports limited interactions, such as a double-tap (or double “click” with a mouse), which changes docking of the window within its parent container, e.g., maximize the window.

The use of a multi-touch enabled GUI can support rapid navigation where command sequences are directly supported without opening one or more levels of menus and sub-menus. Special purpose icons can be defined for particular commands that are frequently used; however, a user interface can quickly become cluttered and difficult to rapidly navigate when too many icons are presented. A number of gestures can be supported in a window content panel to produce commonly defined or application specific results. Detected gestures in a window content panel are typically directed to local content within the window content panel, while gestures detected external to the window are directed toward an operating environment of the window.

### BRIEF DESCRIPTION OF THE INVENTION

One aspect of the invention is a system for multi-touch gesture processing. The system includes a multi-touch display and processing circuitry coupled to the multi-touch display. The processing circuitry is configured to detect a gesture on a gesture target area of a panel toolbar associated with a panel displayed on the multi-touch display. The panel includes panel content displayed in a content area. The gesture target area includes an empty area absent one or more command icons. Based on detection of the gesture, additional content is displayed on the multi-touch display associated with the panel content.

Another aspect of the invention is a method for providing multi-touch gesture processing. The method includes detecting, by processing circuitry coupled to a multi-touch display, a gesture on a gesture target area of a panel toolbar associated with a panel displayed on the multi-touch display. The panel includes panel content displayed in a content area. The gesture target area includes an empty area absent one or more command icons. Based on detecting the gesture, additional content is displayed on the multi-touch display associated with the panel content.

Another aspect of the invention is a computer program product for providing multi-touch gesture processing. The computer program product includes a non-transitory computer readable medium storing instructions for causing processing circuitry coupled to a multi-touch display to implement a method. The method includes detecting a gesture on a gesture target area of a panel toolbar associated with a panel displayed on the multi-touch display. The panel includes panel content displayed in a content area. The gesture target area includes an empty area absent one or more command icons. Based on detecting the gesture, additional content is displayed on the multi-touch display associated with the panel content.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 depicts a block diagram of a multi-touch computer system including a multi-touch display;

FIG. 2 depicts an example of a user interface on the multi-touch display of FIG. 1;

FIG. 3 depicts an example application of a gesture on the user interface of FIG. 2;

FIG. 4 depicts an example of navigation history on the user interface of FIG. 2;

FIG. 5 depicts an example application of a gesture on the user interface of FIG. 2;

FIG. 6 depicts an example of a sharing interface; and

FIG. 7 depicts a process for multi-touch gesture processing in accordance with exemplary embodiments.

The detailed description explains embodiments of the invention, together with advantages and features, by way of example with reference to the drawings.

### DETAILED DESCRIPTION OF THE INVENTION

Exemplary embodiments provide multi-touch gesture processing. A multi-touch environment can display a panel with panel content and an associated panel toolbar. A gesture language is defined as actions associated with gestures applied as touch input to the panel. The panel toolbar may include one or more command icons and an empty area absent any command icons. All or a portion of the empty area of the panel toolbar provides a gesture target area, where different commands can be assigned to the same gestures that are recognized on the panel. By utilizing the panel toolbar as a gesture target area for detecting gestures, additional touch-based gestures can be defined and processed while supporting existing gesture processing in other user interface locations.

For example, upon detecting a pinch-zoom gesture on the panel toolbar, rather than graphically rescaling content, exemplary embodiments trigger display of a navigation history. The navigation history may provide a graphical thumbnail view of a recent history of instances of previously displayed panel content. Selecting an instance may result in displaying the associated previously displayed panel content and removing display of the navigation history. As a further example, upon detecting a touch-hold gesture on the panel toolbar, rather than performing a default action defined for the panel, a sharing mode can be initiated where the current panel content or an element thereof can be shared with one or more sharing targets. A pop-up display may be used for selection of sharing targets as a sharing interface.

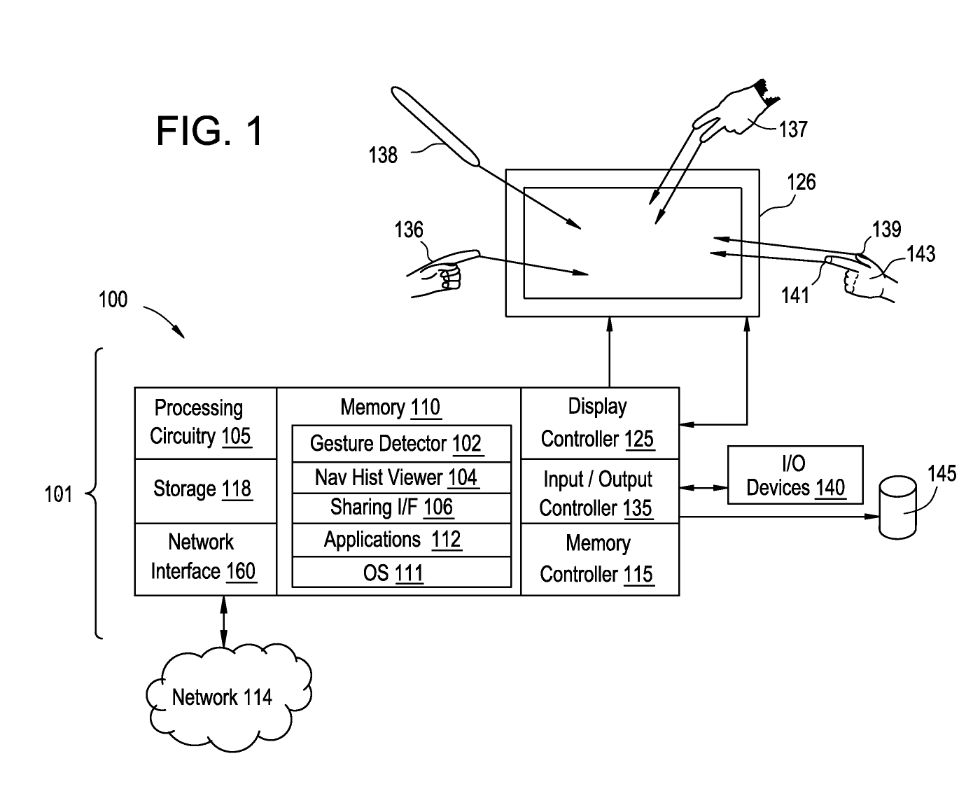

FIG. 1 illustrates an exemplary embodiment of a multi-touch computer system 100 that can be implemented as a touch-sensitive computing device as described herein. The multi-touch computer system 100 can be utilized in a variety of environments such as a control system for controlling processes, plants such as power production plants, and other environments known in the art. The methods described herein can be implemented in software (e.g., firmware), hardware, or a combination thereof. In exemplary embodiments, the methods described herein are implemented in software, as one or more executable programs, and executed by a special or general-purpose digital computer, such as a personal computer, mobile device, workstation, minicomputer, or mainframe computer operably coupled to or integrated with a multi-touch display. The multi-touch computer system 100 therefore includes a processing system 101 interfaced to a multi-touch display 126. The multi-touch display 126 can display text and images, as well as recognize the presence of one or more points of contact as input.

In exemplary embodiments, in terms of hardware architecture, as shown in FIG. 1, the processing system 101 includes processing circuitry 105, memory 110 coupled to a memory controller 115, and one or more input and/or output (I/O) devices 140, 145 (or peripherals) that are communicatively coupled via a local input/output controller 135. The input/output controller 135 can be, but is not limited to, one or more buses or other wired or wireless connections, as is known in the art. The input/output controller 135 may have additional elements, which are omitted for simplicity, such as controllers, buffers (caches), drivers, repeaters, and receivers, to enable communications. Further, the input/output controller 135 may include address, control, and/or data connections to enable appropriate communications among the aforementioned components. The processing system 101 can further include a display controller 125 coupled to the multi-touch display 126. The display controller 125 may drive output to be rendered on the multi-touch display 126.

The processing circuitry 105 is hardware for executing software, particularly software stored in memory 110. The processing circuitry 105 can include any custom made or commercially available processor, a central processing unit (CPU), an auxiliary processor among several processors associated with the processing system 101, a semiconductor based microprocessor (in the form of a microchip or chip set), a macroprocessor, or generally any device for executing software instructions.

The memory 110 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), flash memory, memory card, programmable read only memory (PROM), tape, compact disc read only memory (CD-ROM), digital versatile disc (DVD), disk, diskette, cartridge, cassette or the like, etc.). Moreover, the memory 110 may incorporate electronic, magnetic, optical, and/or other types of storage media. The memory 110 can have a distributed architecture, where various components are situated remote from one another but can be accessed by the processing circuitry 105.

Software in memory 110 may include one or more separate programs, each of which includes an ordered listing of executable instructions for implementing logical functions. In the example of FIG. 1, the software in memory 110 includes a gesture detector 102, a navigation history viewer 104, a sharing interface 106, a suitable operating system (OS) 111, and various applications 112. The OS 111 essentially controls the execution of computer programs, such as various modules as described herein, and provides scheduling, input-output control, file and data management, memory management, communication control and related services. Various user interfaces can be provided by the OS 111, the gesture detector 102, the navigation history viewer 104, the sharing interface 106, the applications 112, or a combination thereof The gesture detector 102 can process touch-based inputs received via the multi-touch display 126 and initiate the navigation history viewer 104, the sharing interface 106, or the applications 112 in response to the touch-based inputs as further described herein.

The gesture detector 102, the navigation history viewer 104, and/or the sharing interface 106 may be implemented in the form of a source program, executable program (object code), script, or any other entity comprising a set of instructions to be performed. When a source program, then the program may be translated via a compiler, assembler, interpreter, or the like, that may or may not be included within the memory 110, so as to operate properly in conjunction with the OS 111 and/or the applications 112. Furthermore, the gesture detector 102, the navigation history viewer 104, and/or the sharing interface 106 can be written in an object oriented programming language, which has classes of data and methods, or a procedure programming language, which has routines, subroutines, and/or functions.

In exemplary embodiments, the input/output controller 135 receives touch-based inputs from the multi-touch display 126 as detected touches, gestures, and/or movements. The multi-touch display 126 can detect input from one finger 136, multiple fingers 137, a stylus 138, and/or other sources (not depicted). The multiple fingers 137 can include a thumb 139 in combination with another finger 141, such as an index finger, on a same user hand 143. Multiple inputs can be received contemporaneously or sequentially from one or more users. In one example, the multi-touch display 126 includes infrared (IR) sensing capabilities to detect touches, shapes, and/or scannable code labels.

Other output devices such as the I/O devices 140, 145 may include input or output devices, for example but not limited to a printer, a scanner, a microphone, speakers, a secondary display, and the like. The I/O devices 140, 145 may further include devices that communicate both inputs and outputs, for instance but not limited to, components of a wireless interface such as a network interface card (NIC) or modulator/demodulator (for accessing other files, devices, systems, or a network), a radio frequency (RF) or other transceiver, a telephonic interface, a bridge, a router, a mobile device, a portable memory storage device, and the like.

In exemplary embodiments, the system 100 can further include a network interface 160 for coupling to a network 114. The network 114 can be an IP-based network for communication between the processing system 101 and any external server, client and the like via a broadband connection. The network 114 transmits and receives data between the processing system 101 and external systems. In exemplary embodiments, network 114 can be a managed IP network administered by a service provider. The network 114 may be implemented in a wireless fashion, e.g., using wireless protocols and technologies, such as WiFi, WiMax, etc. The network 114 can also be a packet-switched network such as a local area network, wide area network, metropolitan area network, Internet network, or other similar type of network environment. The network 114 may be a fixed wireless network, a wireless local area network (LAN), a wireless wide area network (WAN), a personal area network (PAN), a virtual private network (VPN), intranet or other suitable network system and includes equipment for receiving and transmitting signals.

If the processing system 101 is a PC, workstation, intelligent device or the like, software in the memory 110 may further include a basic input output system (BIOS) (omitted for simplicity). The BIOS is a set of essential software routines that initialize and test hardware at startup, start the OS 111, and support the transfer of data among the hardware devices. The BIOS is stored in ROM so that the BIOS can be executed when the processing system 101 is activated.

When the processing system 101 is in operation, the processing circuitry 105 is configured to execute software stored within the memory 110, to communicate data to and from the memory 110, and to generally control operations of the processing system 101 pursuant to the software. The gesture detector 102, the navigation history viewer 104, the sharing interface 106, the OS 111, and the applications 112 in whole or in part, but typically the latter, are read by the processing circuitry 105, perhaps buffered within the processing circuitry 105, and then executed.

When the systems and methods described herein are implemented in software, as is shown in FIG. 1, the methods can be stored on any computer readable medium, such as storage 118, for use by or in connection with any computer related system or method.

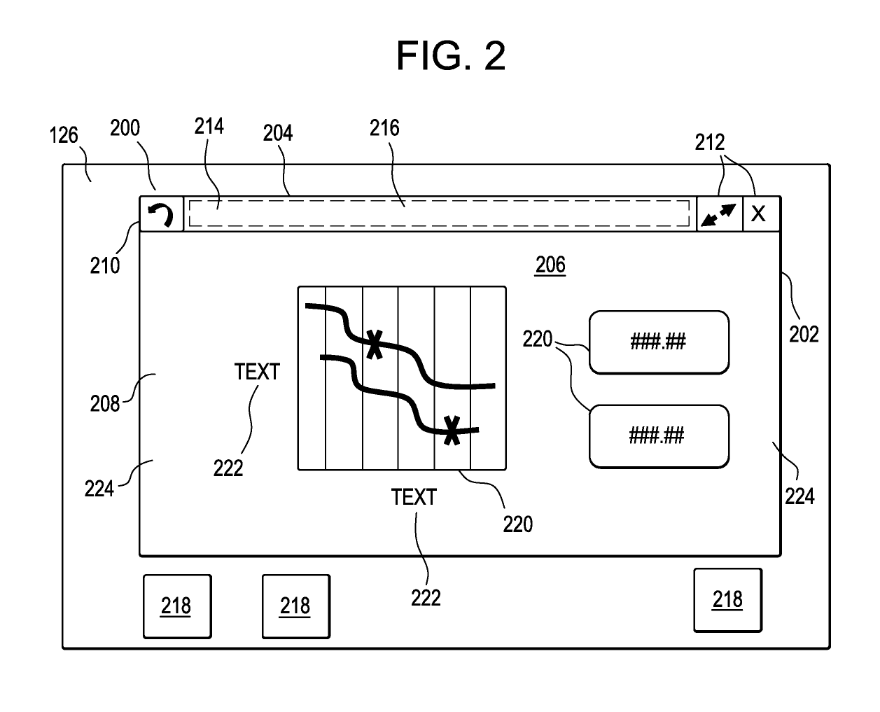

FIG. 2 depicts an example of a user interface 200, which is interactively displayed on the multi-touch display 126 of FIG. 1. In the example of FIG. 2, the user interface 200 operates in a touch-based environment. The user interface 200 may display a variety of text and graphics on the multi-touch display 126. The user interface 200 may be generated by the processing circuitry 105 of FIG. 1 executing the OS 111 and applications 112 of FIG. 1. The user interface 200 is configured to receive touch-based inputs on the multi-touch display 126 and respond thereto.

In the example of FIG. 2, the user interface 200 includes a panel 202 associated with a panel toolbar 204. The panel 202 displays panel content 206 in a content area 208. The panel toolbar 204 includes a tool-specific quick command 210 and docking commands 212, which are examples of command icons. The panel toolbar 204 may be selectively displayed based on detection of a swipe-down gesture on the panel 202 or movement of the panel 202. Alternatively, the panel toolbar 204 can be persistently displayed. The panel toolbar 204 also includes a gesture target area 214 in an empty area 216 of the panel toolbar 204 absent one or more command icons. In the example of FIG. 2, the tool-specific quick command 210 is an undo function that can be applied to a most recent action performed on the panel content 206. The docking commands 212 include maximize and close commands in this example. Additional or fewer command icons can be included on the panel toolbar 204, where at least one area not populated with command icons is used as the gesture target area 214 on the panel toolbar 204. There can also be additional command icons, such as icons 218, defined external to the panel 202 and panel toolbar 204 to launch other tools or trigger other actions.

The panel content 206 can include a combination of graphical elements 220 and text elements 222. The panel content 206 can change based on user interactions, including navigation to other views or tools. Applying a touch-based gesture to the panel content 206 can invoke a particular action. For example, applying a swiping gesture to a perimeter 224 of the panel 202 can change the panel content 206 to display other data sets or a different level of data in a hierarchy. As a further example, a relative zoom level of the panel content 206 can be adjusted by zooming in or out based on a pinch-zoom gesture applied to the panel content 206. In exemplary embodiments, gestures applied to the gesture target area 214 have a unique or different definition than when performed directly over the panel content 206.

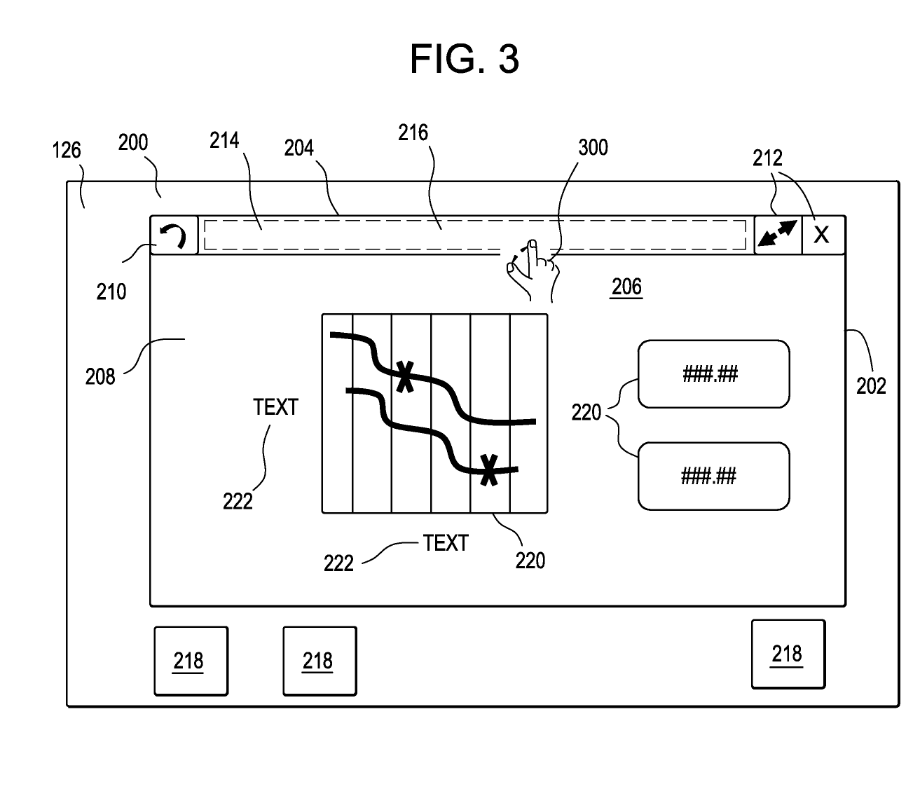

FIG. 3 illustrates application of a pinch-zoom gesture 300 applied to the gesture target area 214 on the panel toolbar 204. In this example, the pinch-zoom gesture 300 includes touching the gesture target area 214 with a user thumb and finger and sliding the user thumb and finger apart from each other, where such a gesture would be interpreted as a zoom-out to enlarge the graphical elements 220 and text elements 222 of the panel content 206 when detected over the panel content 206. The gesture detector 102 of FIG. 1 can detect and distinguish between various gestures over the panel content 206 and the gesture target area 214, while taking a corresponding action in response thereto.

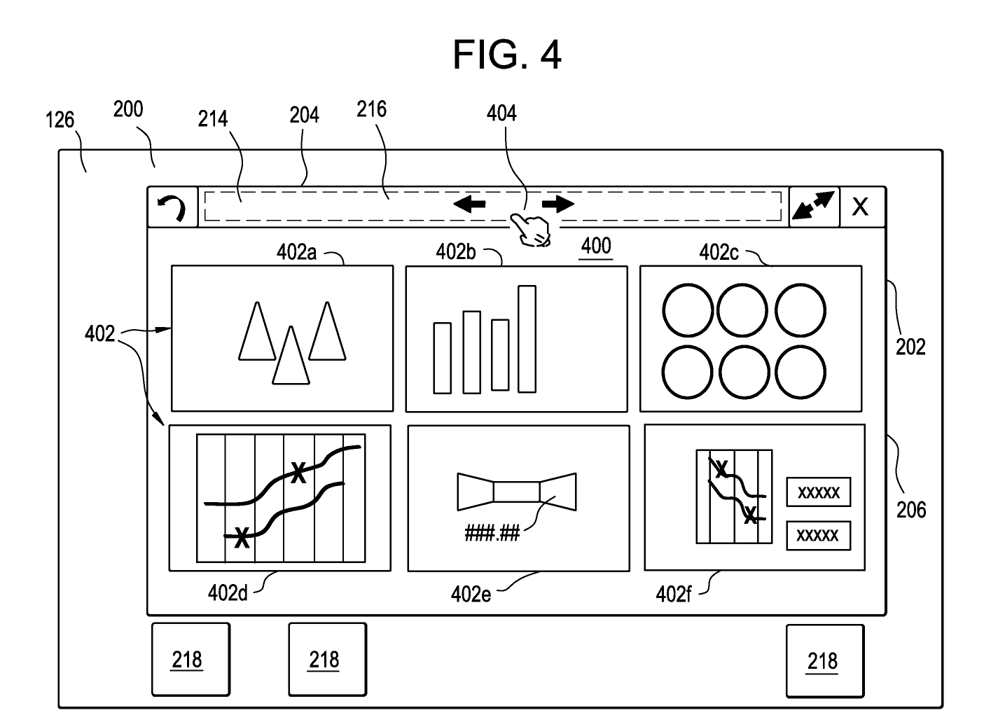

FIG. 4 depicts an example of a navigation history 400 of the panel content 206 on the user interface 200 of FIG. 2. The navigation history viewer 104 of

FIG. 1 can display the navigation history 400 of the panel content 206 on the multi-touch display 126 as a sequence of previously displayed panel content 402. In the example of FIG. 4, the sequence of previously displayed panel content 402 includes instances 402a, 402b, 402c, 402d, 402e, and 402f that are formatted as thumbnail views, with instance 402f being the most recently viewed instance of the previously displayed panel content 402. Upon detecting a selection of one of the instances of the previously displayed panel content 402, the navigation history viewer 104 of FIG. 1 can update the panel content 206 to display the instance of the previously displayed panel content 402 based on the selection. For example, tapping on instance 402b would enlarge instance 402b, setting the panel content 206 to the instance 402b.

Where the sequence of previously displayed panel content 402 available for selection is greater than a number of instances of the previously displayed panel content 402 that can be reasonably displayed at one time, the gesture detector 102 of FIG. 1 can be configured to detect a swipe gesture 404 on the gesture target area 214 which is interpreted by the navigation history viewer 104 of FIG. 1 as a scroll request. Accordingly, the navigation history 400 scrolls to display additional instances of the previously displayed panel content from the sequence of previously displayed panel content 402, i.e., instances before instance 402a. After scrolling back, scrolling forward toward the most recently viewed instance, i.e., instance 402f is also supported based on applying the swipe gesture 404. Thus, the number of instances in the sequence of previously displayed panel content 402 available for selection is not limited by display size constraints of the multi-touch display 126.

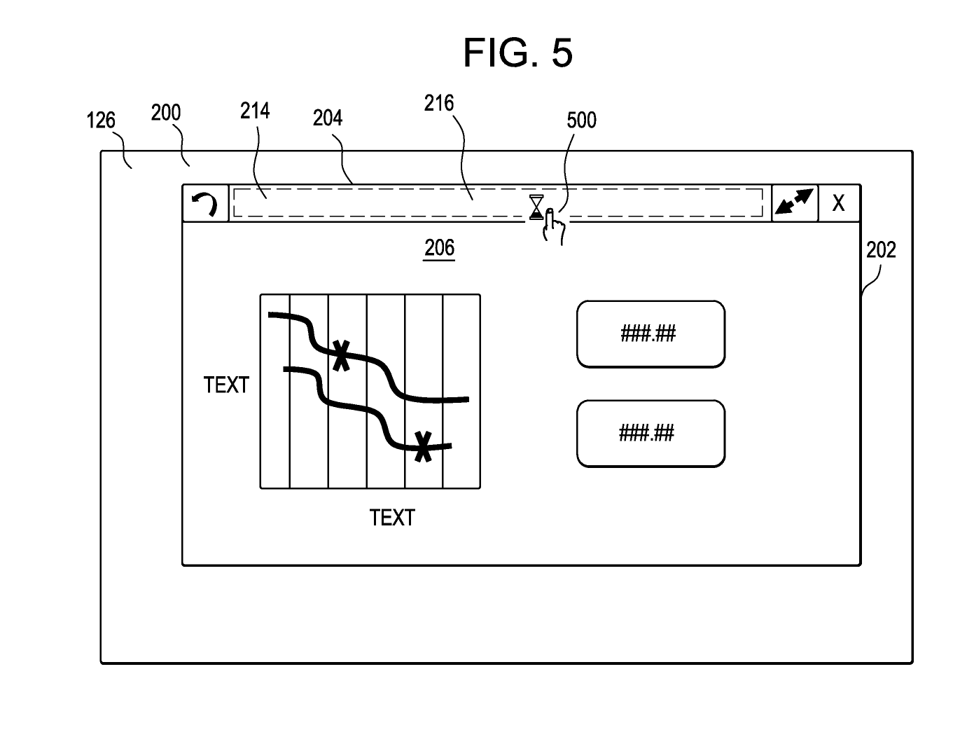

FIG. 5 depicts an example application of a gesture 500 on the user interface 200 of FIG. 2 on the multi-touch display 126 of FIG. 1. The gesture detector 102 of FIG. 1 can be configured to detect the gesture 500 on the gesture target area 214 in an empty area 216 of the panel toolbar 204 and interpret the gesture 500 as a share mode request. In an exemplary embodiment, the gesture 500 is a tap-hold gesture. The share mode request can enable sharing of the panel content 206 displayed on the panel 202. Sharing may be managed through a sharing interface, such as the sharing interface 106 of FIG. 1.

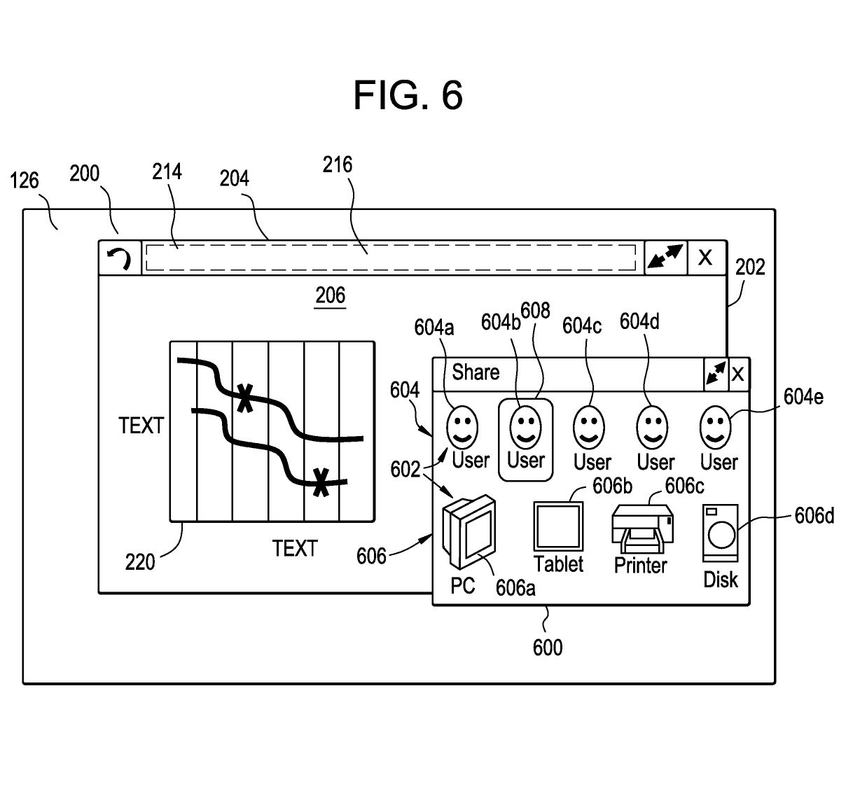

FIG. 6 depicts a sharing interface 600 that represents an example of the sharing interface 106 of FIG. 1. As described in reference to FIG. 5, the sharing interface 600 can be enabled based on gesture detection in the gesture target area 214 in an empty area 216 of the panel toolbar 204. In the example of FIG. 6, the sharing interface 600 is a pop-up that appears in conjunction with the panel content 206. The sharing interface 600 displays a number of sharing targets 602 that can include users 604 and/or devices 606. The sharing interface 600 displays graphical symbols for users 604a, 604b, 604c, 604d, and 604e, as well as graphical symbols for devices 606a, 606b, 606c, and 606d. In the example of FIG. 6, device 606a is a PC, device 606b is a tablet computer, device 606c is a printer, and device 606d is a disk; however, any number or type of devices 606 can be supported as sharing targets 602. Furthermore, any number of users 604 can be supported as sharing targets 602. Selection of one or more of the sharing targets 602 can result in highlighting 608 or other visual cues to indicate which of the sharing targets 602 are selected for sharing. Sharing provides a copy of at least one element of the panel content 206 to at least one of the sharing targets 602. For example, one of the graphical elements 220 can be selected for sharing or all elements of the panel content 206 can be shared, e.g., as a snapshot or image, to one or more of the sharing targets 602.

While the example of FIG. 6 depicts the sharing interface 600 as a pop-up display, other options can be supported. For instance, one or more of the sharing targets 602 can be hidden on the user interface 200 and made visible upon detection of a share mode request.

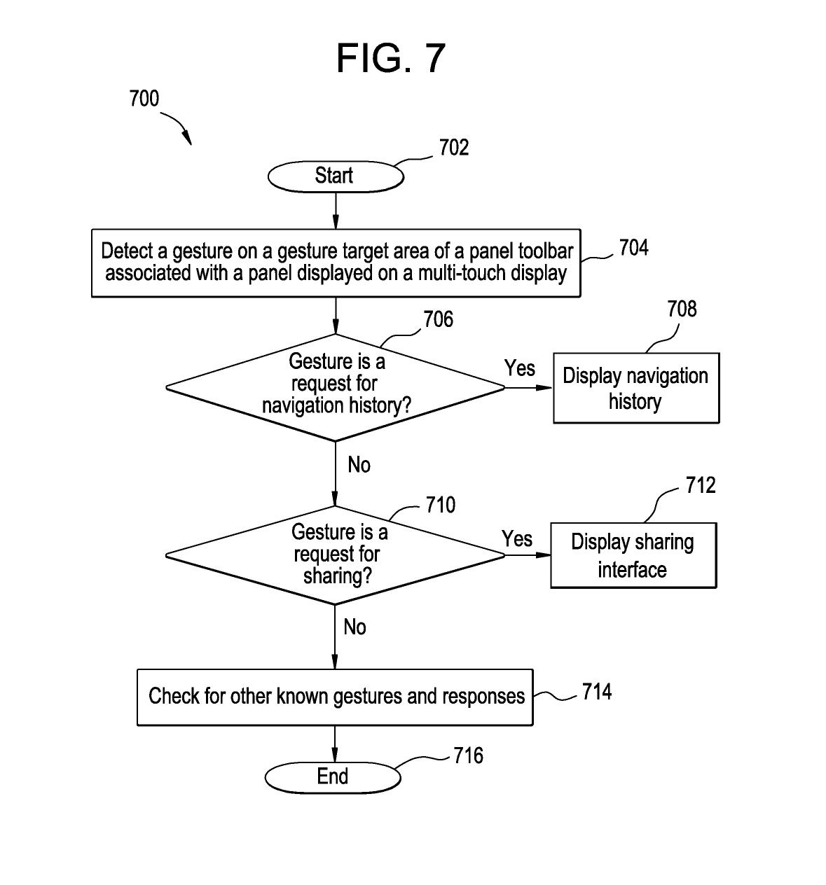

FIG. 7 depicts a process 700 for multi-touch gesture processing in accordance with exemplary embodiments. The process 700 is described in reference to FIGS. 1-7. The processing circuitry 105 of FIG. 1 may run the gesture detector 102 of FIG. 1 to support gesture detection on a user interface, such as the user interface 200 of FIG. 2, and trigger corresponding actions in response thereto. As part of the user interface 200, the processing circuitry 105 can interactively control display of the panel 202 and panel toolbar 204 of FIG. 2.

The process 700 begins at block 702 and transitions to block 704. At block 704, the processing circuitry 105 detects a gesture on the gesture target area 214 of the panel toolbar 204 associated with the panel 202 displayed on the multi-touch display 126. The panel 202 includes panel content 206 displayed in the content area 208. The gesture target area 214 includes the empty area 216 absent one or more command icons, such as command icons 210 and 212.

At block 706, the processing circuitry 105 determines whether the gesture is a request for navigation history 400, such as gesture 300 of FIG. 3. At block 708, based on detection of the gesture 300, additional content associated with the panel content 206 is displayed on the multi-touch display 126, which is the navigation history 400 of the panel content 206. The navigation history 400 of the panel content 206 can be displayed as a sequence of previously displayed panel content 402. Upon detecting a selection of an instance of the previously displayed panel content 402, the panel content 206 is updated to display the instance of the previously displayed panel content 402 based on the selection, e.g., change from instance 402f to 402c. As previously described, the gesture 300 can be a pinch-zoom gesture, and a swipe gesture 404 can be subsequently detected on the gesture target area 214. The navigation history 400 can scroll based on the swipe gesture 404 to display additional instances of the previously displayed panel content 402 from the sequence of previously displayed panel content 402.

At block 710, the processing circuitry 105 determines whether the gesture is a sharing mode request, such as gesture 500 of FIG. 5. At block 712, based on detection of the gesture 500, additional content associated with the panel content 206 is displayed on the multi-touch display 126, such as the sharing interface 600 of FIG. 6 to share elements of the panel content 206. The gesture 500 can be a tap-hold gesture. The sharing interface 600 is configured to identify one or more sharing targets 602, such as one or more of a user 604 and a device 606, and provide a copy of at least one element of the panel content 206 to at least one of the one or more sharing targets 602. Sharing can include providing a complete copy of the panel content 206 to a sharing target.

At block 714, the processing circuitry 105 determines whether the gesture is another known gesture, and the gesture detector 102 of FIG. 1 triggers a corresponding portion of the OS 111 or applications 112 of FIG. 1 to handle the detected gesture. The process 700 ends at block 716.

Although the examples of FIGS. 2-6 depict only a single panel 202 and associated panel toolbar 204, additional instances of the panel 202 and panel toolbar 204 can also be displayed on the user interface 200. Accordingly, multiple instances of the process 700 can operate in parallel such that gestures can be detected and processed for each displayed panel 202 and panel toolbar 204 on the multi-touch display 126.

In exemplary embodiments, a technical effect is display of additional content on a multi-touch display associated with panel content upon detection of a gesture on a gesture target area of a panel toolbar associated with a panel displayed on the multi-touch display. Defining a gesture language for a particular region, such as an otherwise empty area of a panel toolbar, enables additional commands to be defined beyond those supported elsewhere on the user interface. The panel toolbar is typically associated with container-level operations, such as maximizing or closing the panel. Defining gestures in the panel toolbar enables additional content to be displayed and actions performed without cluttering the panel toolbar with numerous special-purpose icons.

As will be appreciated by one skilled in the art, aspects of the present invention may be embodied as a system, method or computer program product. Accordingly, aspects may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects may take the form of a computer program product embodied in one or more computer readable medium(s) having computer readable program code embodied thereon.

Any combination of one or more computer readable medium(s) may be utilized including a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contains, or stores a program for use by or in connection with an instruction execution system, apparatus, or device.

Program code embodied on a computer readable medium as a non-transitory computer program product may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects are described with reference to flowchart illustrations and/or block diagrams of methods, apparatus (systems) and computer program products according to embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In exemplary embodiments, where the gesture detector 102 of FIG. 1 is implemented in hardware, the methods described herein can implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

While the invention has been described in detail in connection with only a limited number of embodiments, it should be readily understood that the invention is not limited to such disclosed embodiments. Rather, modifications can incorporate any number of variations, alterations, substitutions or equivalent arrangements not heretofore described, but which are commensurate with the spirit and scope of the invention. Additionally, while various embodiments have been described, it is to be understood that aspects may include only some of the described embodiments. Accordingly, the invention is not to be seen as limited by the foregoing description, but is only limited by the scope of the appended claims.

1. A system for multi-touch gesture processing, the system comprising:
a multi-touch display; and
processing circuitry coupled to the multi-touch display, the processing circuitry configured to:
detect a gesture on a gesture target area of a panel toolbar associated with a panel displayed on the multi-touch display, the panel comprising panel content displayed in a content area, and the gesture target area comprising an empty area absent one or more command icons; and
based on detection of the gesture, display additional content on the multi-touch display associated with the panel content.

2. The system according to claim 1, wherein the processing circuitry is further configured to:
display a navigation history of the panel content on the multi-touch display as a sequence of previously displayed panel content based on determining that the gesture is a request to view the navigation history;
detect a selection of an instance of the previously displayed panel content; and
update the panel content to display the instance of the previously displayed panel content based on the selection.

3. The system according to claim 2, wherein the gesture is a pinch-zoom gesture.

4. The system according to claim 2, wherein the processing circuitry is further configured to:
detect a swipe gesture on the gesture target area; and
scroll the navigation history based on the swipe gesture to display additional instances of the previously displayed panel content from the sequence of previously displayed panel content.

5. The system according to claim 1, wherein the processing circuitry is further configured to enable sharing of the panel content with one or more sharing targets based on determining that the gesture is a share mode request.

6. The system according to claim 5, wherein the gesture is a tap-hold gesture.

7. The system according to claim 5, wherein the processing circuitry is further configured to display a sharing interface configured to identify the one or more sharing targets.

8. The system according to claim 5, wherein the one or more sharing targets comprise one or more of a user and a device, and the sharing comprises providing a copy of at least one element of the panel content to at least one of the one or more sharing targets.

9. A method for providing multi-touch gesture processing, the method comprising:
detecting, by processing circuitry coupled to a multi-touch display, a gesture on a gesture target area of a panel toolbar associated with a panel displayed on the multi-touch display, the panel comprising panel content displayed in a content area, and the gesture target area comprising an empty area absent one or more command icons; and
based on detecting the gesture, displaying additional content on the multi-touch display associated with the panel content.

10. The method according to claim 9, further comprising:
displaying a navigation history of the panel content on the multi-touch display as a sequence of previously displayed panel content based on determining that the gesture is a request to view the navigation history;
detecting a selection of an instance of the previously displayed panel content; and
updating the panel content to display the instance of the previously displayed panel content based on the selection.

11. The method according to claim 10, wherein the gesture is a pinch-zoom gesture.

12. The method according to claim 10, further comprising:
detecting a swipe gesture on the gesture target area; and
scrolling the navigation history based on the swipe gesture to display additional instances of the previously displayed panel content from the sequence of previously displayed panel content.

13. The method according to claim 9, further comprising:
based on determining that the gesture is a share mode request, enabling sharing of the panel content with one or more sharing targets.

14. The method according to claim 13, wherein the gesture is a tap-hold gesture.

15. The method according to claim 13, further comprising:
displaying a sharing interface configured to identify the one or more sharing targets.

16. A computer program product for providing multi-touch gesture processing, the computer program product including a non-transitory computer readable medium storing instructions for causing processing circuitry coupled to a multi-touch display to implement a method, the method comprising:
detecting a gesture on a gesture target area of a panel toolbar associated with a panel displayed on the multi-touch display, the panel comprising panel content displayed in a content area, and the gesture target area comprising an empty area absent one or more command icons; and
based on detecting the gesture, displaying additional content on the multi-touch display associated with the panel content.

17. The computer program product according to claim 16, further comprising:
displaying a navigation history of the panel content on the multi-touch display as a sequence of previously displayed panel content based on determining that the gesture is a request to view the navigation history;
detecting a selection of an instance of the previously displayed panel content; and
updating the panel content to display the instance of the previously displayed panel content based on the selection.

18. The computer program product according to claim 17, wherein the gesture is a pinch-zoom gesture.

19. The computer program product according to claim 16, further comprising:
based on determining that the gesture is a share mode request, enabling sharing of the panel content with one or more sharing targets.

20. The computer program product according to claim 19, wherein the gesture is a tap-hold gesture.
